(19) United States
(12) Patent Application Publication
(10) Pub. No.: US 2003/0148183 A1
(43) Pub. Date: Aug. 7, 2003

(54) Non-aqueous electrolyte battery

(76) Inventor: Mikiya Yamasaki, Sumoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/354,117

(22) Filed: Jan. 30, 2003

(30) Foreign Application Priority Data
Jan. 31, 2002 (JP) P. 2002-24171

(51) Int. Cl. H01M 4/50; H01M 10/40

(52) U.S. Cl. 429/231.1; 429/231.3; 429/224; 429/331

(57) ABSTRACT

The inventors provide a non-aqueous electrolyte secondary battery in which the mass ratio of positive active materials, i.e., the mass ratio of lithium cobalt oxide to lithium manganese oxide is adjusted to improve both energy density and safety and in which a solvent containing ethylene carbonate (EC) and propylene carbonate (PC) is used so that the EC content and the PC content can be controlled to prevent swelling and improve both safety at overcharge and safety at a high temperature.

### BACKGROUND OF THE INVENTION

1. Field of the Invention

The present invention relates to a non-aqueous electrolyte battery and particularly to composition of positive electrode active material and electrolyte in the non-aqueous electrolyte battery.

2. Description of the Related Art

A non-aqueous electrolyte battery represented by a lithium ion battery using an alloy or carbon material capable of absorbing/releasing lithium ions as a negative electrode active material and using lithium-containing transition metal oxide such as lithium cobalt oxide (LiCoO₂), lithium nickel oxide (LiNiO₂) or lithium manganese oxide (LiMn₂O₄) as a positive electrode material has been recently put into practical use as a chargeable and dischargeable battery which is small in size, light in weight and high in capacity. The non-aqueous electrolyte battery can be used as a battery used in a portable electronic/communication apparatus such as a small-size video camera, a cellular phone or a notebook type personal computer.

Incidentally, the mainstream of the lithium-containing transition metal oxide used as the positive electrode material in the non-aqueous electrolyte battery is lithium cobalt oxide (LiCoO₂) at present because high energy density can be obtained.

There is however a quantitative problem of natural resources if non-aqueous electrolyte batteries of this type are used not only for recent small-size household appliances represented by portable electronic/communication appliances such as a small-size video camera, a cellular phone, and a notebook type personal computer, but also for large-size apparatuses such as a hybrid car. Therefore, lithium manganese oxide (LiMn₂O₄) rich and inexpensive in terms of natural resources has received much attention as a material substituted for lithium cobalt oxide (LiCoO2) poor and expensive in terms of natural resources.

Lithium manganese oxide, however, has a problem that energy density is low. Various methods have been proposed to solve the problem of low energy density.

On the other hand, lithium cobalt oxide has a problem in safety at overcharge though it is larger in capacity than lithium manganese oxide.

### SUMMARY OF THE INVENTION

The invention is developed in consideration of such circumstances and an object of the invention is to provide a non-aqueous electrolyte secondary battery high in energy density and high in safety.

Therefore, on the basis of various experimental results, the inventors provide a non-aqueous electrolyte secondary battery in which the mass ratio of positive active materials, i.e., the mass ratio of lithium cobalt oxide to lithium manganese oxide is adjusted to improve both energy density and safety and in which a solvent containing ethylene carbonate (EC) and propylene carbonate (PC) is used so that the EC content and the PC content can be controlled to prevent swelling and improve both safety at overcharge and safety at a high temperature.

That is, in the non-aqueous electrolyte secondary battery according to the invention, the positive electrode contains lithium cobalt oxide and lithium manganese oxide as active materials; the mass ratio of lithium cobalt oxide to lithium manganese oxide is adjusted to be in a range of from 50/50 to 80/20; the electrolyte is lithium salt dissolved in an organic solvent which contains ethylene carbonate (EC) and propylene carbonate (PC); the EC content is not smaller than 25% by volume but not larger than 50% by volume with respect to the total amount of the organic solvent; and the PC content is not smaller than 5% by volume but not larger than the EC content with respect to the total amount of the organic solvent.

Preferably, the electrolyte is prepared in such a manner that a polymerizable compound containing a compound having either acryloyl group (CH₂═CHCO—O—) or methacryloyl group (CH₂═C(CH₃)CO—O—) is added to the electrolyte and thermally polymerized to be gelated.

Because lithium manganese oxide functions as a strong oxidizing agent, it reacts with electrolytic liquid and electrolytic salt to produce a large amount of gas. As a result, the performance of the battery is lowered. Moreover, liquid leakage occurs as well as the shape of the battery is changed by abnormality of inner pressure. Hence, the safety of the battery is lowered.

When lithium cobalt oxide is added to or mixed with lithium manganese oxide, both the amount of produced gas and the voltage drop can be however reduced. Hence, both capacity retention rate and capacity recovery rate can be increased.

It has been generally conceived that the discharge operating voltage in use of a mixture of lithium cobalt oxide and lithium manganese oxide will become lower than that in use of only lithium manganese oxide because the discharge operating voltage of lithium cobalt oxide is lower than that of lithium manganese oxide. In practice, it is however found that the discharge operating voltage in use of the mixture becomes higher because lithium cobalt oxide is more excellent in electron-conducting characteristic than lithium manganese oxide.

If the mass ratio of lithium cobalt oxide to lithium manganese oxide is higher than 80/20, overcharge characteristic is however lowered because the influence of only lithium cobalt oxide becomes intensive. Accordingly, it is conceived that the lowering of the overcharge characteristic can be suppressed by adjustment of the EC content and the PC content in the invention.

More preferably, the mass ratio of lithium cobalt oxide to lithium manganese oxide is selected to be not lower than 50/50.

When PC is contained in a non-aqueous solvent, it is conceived not clearly but vaguely that the amount of produced gas is reduced more greatly because the PC forms a decomposed film on the electrode and relaxes reaction with the non-aqueous electrolyte. For these reasons, there can be consequently obtained a non-aqueous electrolyte secondary battery which is excellent both in discharge preservation stability and in high-temperature preservation stability, high both in discharge operating voltage and in energy density and improved in safety.

If the PC content is larger than the EC content, the effect of relaxing reaction of lithium cobalt oxide with the non-aqueous electrolyte is however lowered.

Preferably, the EC content is selected to be in a range of from 25% by volume to 50% by volume. More preferably, when the EC content is not smaller than 30% by volume, the resulting battery can pass a 3 It-overcharge test.

The large characteristic of the invention is that the positive electrode active material prepared by adding/mixing lithium cobalt oxide to/with lithium manganese oxide can be applied not only to a non-aqueous electrolyte secondary battery using an organic electrolytic solution but also to a non-aqueous electrolyte battery using a gelated polymer electrolyte. Polymer electrolyte gel has a problem in the liquid-containing capacity of the positive electrode because the viscosity of the polymer electrolyte gel is higher than that of the electrolytic solution. In the positive electrode prepared by adding/mixing lithium cobalt oxide to/with lithium manganese oxide, it is however possible to attain increase in energy density compared with that of lithium manganese oxide. As a result, the thickness of the positive electrode can be reduced. Hence, it is conceived that the problem of liquid-containing capacity can be solved.

As a polymer electrolyte, there can be used a polymer electrolyte prepared by gelation of a combination of: a polymerizable compound having either acryloyl group (CH₂═CHCO—) or methacryloyl group (CH₂═C(CH₃)CO—); a solvent containing PC and EC; and lithium salt.

### DESCRIPTION OF THE PREFERRED EMBODIMENTS

An embodiment of the invention will be described below.

1. Production of Positive Electrode

(1) Positive Electrode using Lithium Manganese oxide and Lithium Cobalt oxide

Lithium manganese oxide represented by LiMn₂O₄ and lithium cobalt oxide represented by LiCoO₂ were mixed at a predetermined mass ratio. A proper amount of electrically conductive carbon material and a proper amount of graphite were added into and mixed with the mixture of lithium manganese oxide and lithium cobalt oxide. The resulting mixture powder was packed in a mixer (e.g., MECHANO FUSION SYSTEM (AM-15F) made by HOSOKAWA MICRON). The mixer was operated at a rotational speed of 1500 rpm for 10 minutes to generate compression, impact and shear action to mix the mixture powder as a mixture positive electrode active material. By this mixing, lithium cobalt oxide was brought into electrical contact with lithium manganese oxide. Then, a fluororesin-based binder was mixed with the mixture positive electrode active material at a predetermined ratio to form a positive electrode composite. Then, the positive electrode composite was applied on opposite surfaces of a positive electrode collector of aluminum foil and dried. Then, the positive electrode collector with the positive electrode composite was rolled into a predetermined thickness to thereby form a positive electrode plate.

Incidentally, a positive electrode plate produced by mixing lithium cobalt oxide (represented by LiCoO₂) with lithium manganese oxide (represented by LiMn₂O₄) at a mixture ratio of 50:50 (the mixture ratio all expressed in mass ratio hereinafter) is referred to as “positive electrode plate a”. A positive electrode plate produced by mixing lithium cobalt oxide (represented by LiCoO₂) with lithium manganese oxide (represented by LiMn₂O₄) at a mixture ratio of 80:20 is referred to as “positive electrode plate b”.

(2) Positive Electrode for Comparative Example

A positive electrode plate produced by mixing lithium cobalt oxide (represented by LiCoO₂) with lithium manganese oxide (represented by LiMn₂O₄) at a mixture ratio of 85:15 is referred to as “positive electrode plate x”. A positive electrode plate produced by mixing lithium cobalt oxide (represented by LiCoO₂) with lithium manganese oxide (represented by LiMn₂O₄) at a mixture ratio of 45:55 is referred to as “positive electrode plate v”.

2. Production of Negative Electrode

A negative electrode active material capable of inserting/releasing lithium ions and a rubber-based binder were mixed with water to form a negative electrode composite. The negative electrode composite was applied on opposite surfaces of a negative electrode collector of copper foil. Then, the negative electrode collector with the negative electrode composite was rolled to form a negative electrode plate. Incidentally, as the negative electrode active material, there can be preferably used a carbon-based material capable of inserting/releasing lithium ions, such as graphite, carbon black, coke, vitreous carbon, carbon fiber, or sintered compact thereof.

Alternatively, there may be used oxide capable of inserting/releasing lithium ions, such as tin oxide or titanium oxide.

3. Adjustment of Electrolytic Solution

(1) Electrolytic Solution for the Invention

Organic solvents were prepared in such a manner that the amount of ethylene carbonate (EC) and the amount of propylene carbonate (PC) contained in each of the organic solvents were changed while diethyl carbonate (DEC) was contained as a residual part of the organic solvent. That is, 1 mol/l of lithium hexafluorophosphate as electrolytic salt was dissolved in a mixture solvent containing EC, PC and DEC mixed at the volume ratio of 25:5:70 to thereby prepare an electrolytic solution α1. Similarly, an electrolytic solution α2 was prepared by using a mixture solvent containing EC, PC and DEC mixed at the volume ratio of 25:25:50; an electrolytic solution α3 was prepared by using a mixture solvent containing EC, PC and DEC mixed at the volume ratio of 30:5:65; an electrolytic solution α4 was prepared by using a mixture solvent containing EC, PC and DEC mixed at the volume ratio of 40:5:55; an electrolytic solution α5 was prepared by using a mixture solvent containing EC, PC and DEC mixed at the volume ratio of 40:40:20; an electrolytic solution α6 was prepared by using a mixture solvent containing EC, PC and DEC mixed at the volume ratio of 50:5:45; and an electrolytic solution α7 was prepared by using a mixture solvent containing EC, PC and DEC mixed at the volume ratio of 50:50:0.

(2) Electrolytic Solution for Comparative Example

Like the electrolytic solution for the invention, an electrolytic solution β1 was prepared by using a mixture solvent containing EC, PC and DEC mixed at the volume ratio of 20:5:75; an electrolytic solution β2 was prepared by using a mixture solvent containing EC, PC and DEC mixed at the volume ratio of 25:0:75; an electrolytic solution β3 was prepared by using a mixture solvent containing EC, PC and DEC mixed at the volume ratio of 25:30:45; an electrolytic solution β4 was prepared by using a mixture solvent containing EC, PC and DEC mixed at the volume ratio of 40:0:60; an electrolytic solution β5 was prepared by using a mixture solvent containing EC, PC and DEC mixed at the volume ratio of 40:45:15; an electrolytic solution β6 was prepared by using a mixture solvent containing EC, PC and DEC mixed at the volume ratio of 50:0:50; and an electrolytic solution β7 was prepared by using a mixture solvent containing EC, PC and DEC mixed at the volume ratio of 55:5:40.

Besides the mixture solvent containing ethylene carbonate (EC), propylene carbonate (PC) and diethyl carbonate (DEC), an aprotic solvent incapable of supplying hydrogen ions and, for example, mixed with dimethyl carbonate (DMC) or ethyl methyl carbonate (EMC) may be used as the mixture solvent. Besides the LiPF₆, imide salt represented by LiPF₆₋ₓ(C₂F₅)ₓ, LiBF₄, LiClO₄ and LiN(SO₂C₂F₅)₂ may be used as the electrolyte.

4. Production of Lithium Ion Test Battery

### (1) EXAMPLE 1

A lead was attached to the positive electrode plate a produced in the aforementioned manner while a lead was attached to the negative electrode plate produced in the aforementioned manner. These positive and negative electrode plates were wound like a volute through a propylene separator to produce a volute electrode body. After these volute electrode bodies produced thus were inserted into an aluminum outer package, each lead was connected to a positive or negative electrode terminal.

Into a mixture solution containing the electrolyte α1 prepared in the aforementioned manner and polypropylene glycol diacrylate represented by the following chemical formula 1 in the mass ratio of 12:1, 5000 ppm of t-hexyl peroxypivalate was added as a polymerization initiator. The resulting mixture solution was injected into the outer package. Then, the outer package was sealed and left quietly in an oven at 60° C. for 3 hours, so that the mixture solution was cured.

[Chemical Formula 1]

Chemical Formula 1

CH₂═CHCO—O—(CH(CH₃)—CH₂—O)ₙ—COCH═CH₂

In this manner, a battery A1 having a nominal capacity of 600 mAH was produced according to the invention. Incidentally, any shape such as a flat surface, a polygonal shape or a cylindrical shape may be used as the shape of the battery. The size of the battery is not particularly limited.

Incidentally, in the invention, a compound having acryloyl group such as polypropylene glycol diacrylate, or a compound having methacryloyl group such as polypropylene glycol dimethacrylate represented by the following chemical formula 2 may be preferably used. This is because such a compound used can be easily dissolved in the electrolytic solution and can be easily polymerized by heat or the like.

[Chemical Formula 2]

Chemical Formula 2

CH₂═C(CH₃)CO—O—(CH(CH₃)—CH₂—O)ₙ—COC(CH₃)═CH₂ n=3

### (2) EXAMPLES 2 TO 7

Batteries A2 to A7 according to the invention were produced in the same manner as in Example 1 except that electrolytes α2 to α7 were used while the positive electrode plate a was used.

### (3) EXAMPLES 8 TO 14

Batteries B1 to B7 according to the invention were produced in the same manner as in Example 1 except that electrolytes α1 to α7 were used while a positive electrode plate b was used.

### (4) COMPARATIVE EXAMPLES 1 AND 2

Comparative batteries X1 and X2 were produced in the same manner as in Example 1 except that electrolytes α1 and α7 were used while a positive electrode plate x was used.

### (5) COMPARATIVE EXAMPLES 3 AND 4

Comparative batteries Y1 and Y2 were produced in the same manner as in Example 1 except that electrolytes α1 and α7 were used while a positive electrode plate v was used.

### (6) COMPARATIVE EXAMPLES 5 TO 11

Comparative batteries Z1 to Z7 were produced in the same manner as in Example 1 except that electrolytes β1 to β7 were used while the positive electrode plate a was used.

### (7) COMPARATIVE EXAMPLES 12 TO 18

Comparative batteries W1 to W7 were produced in the same manner as in Example 1 except that electrolytes β1 to β7 were used while the positive electrode plate b was used.

5. Tests

(1) After-Charge High-Temperature Preservation Test

Each of the batteries A1 to A7, B1 to B7, X1 and X2, Y1 and Y2, Z1 to Z7 and W1 to W7 produced in the aforementioned manner was charged up to 4.2 V at a charging current of 600 mA (1It) in a room-temperature atmosphere. After arrival at 4.2 V, the battery was charged with a constant voltage of 4.2 V until the charging current became not larger than 30 mA. Then, battery charging paused for 10 minutes. Then, the battery was discharged at a discharging current of 600 mA (1It) until the discharge end voltage reached 2.75 V. That is, 4.2 V-600 mA constant-current constant-voltage charge and 600 mA constant-current discharge were performed. After the battery was charged and discharged in the aforementioned manner, the battery was charged up to 4.2 V at a charging current of 600 mA (1It) in the room-temperature atmosphere. After arrival at 4.2 V, the battery was charged with a constant voltage of 4.2 V until the charging current became not larger than 30 mA. Then, the battery was preserved in an 80° C. atmosphere for 4 days.

The case where swelling after preservation at 80° C. for 4 days after charging in this condition was not larger than 1 mm was judged as O.K. The case where swelling was larger than 1 mm was judged as N.G.

(2) Overcharge Test

Every 15 batteries were charged at a charging current of 1200 mA (2It). In the overcharge test, there was used a circuit which was formed so that the charging current was cut off when the battery voltage reached 12 V. The case where explosive firing did not occur was judged as O.K. The case where explosive firing occurred was judged as N.G.

(3) 150° C. Thermal Test

Every 15 batteries, which were charged up to 4.2 V at a charging current of 600 mA (1It) in a room-temperature atmosphere and further charged with a constant voltage of 4.2 V after arrival at 4.2 V until the charging current became not larger than 30 mA, were heated from the room temperature to 150° C. at the rate of 5° C./min in an oven. The case where explosive firing did not occur was judged as O.K. The case where explosive firing occurred was judged as N.G.

(4) 60° C. Cycle Characteristic

A cycle test was performed in the same charging/discharging condition as in the test (1) but in a 60° C. atmosphere. Capacity retention rate (%)=(Initial capacity/Capacity at 300 Cycles)×100

Results of the aforementioned tests were as shown in Tables 1 to 4.

6. Examination of Composition of Positive Electrode Active Material

The batteries using electrolytic solutions containing 25% or 50% of EC and 5% or more of PC were used. That is, the batteries A1, A7, B1 and B7 according to the invention and the comparative batteries X1, X2, Y1 and Y2 were used. While the mass ratio of active materials, that is, the mass ratio of lithium cobalt oxide (LiCoO₂) to lithium manganese oxide (LiMn₂O₄) was changed, characteristic of each of the batteries was measured. Results of the measurement were as shown in Table 1.

TABLE 1
Influence of LiCoO₂/LiMn₂O₄ Ratio on Characteristic

| | Active | | | | | | | |
|---|---|---|---|---|---|---|---|---|
| | material | | | | 2It | | 80° C. 4-day | 60° C. |
| | mass ratio | | | | over- | 150° C. | preservation | cycle |
| | LiCoO₂/ | EC | PC | DEC | charge | thermal | after | characteristic |
| | LiMn₂O₄ | (vol %) | (vol %) | (vol %) | test | test | charge | (%) |
| Comparative | 85/15 | 25 | 5 | 70 | N.G. | N.G. | O.K. | 83% |
| battery X1 | | | | | | | | |
| Inventive | 80/20 | 25 | 5 | 70 | O.K. | O.K. | O.K. | 86% |
| battery B1 | | | | | | | | |
| Inventive | 50/50 | 25 | 5 | 70 | O.K. | O.K. | O.K. | 84% |
| battery A1 | | | | | | | | |
| Comparative | 45/55 | 25 | 5 | 70 | O.K. | O.K. | O.K. | 73% |
| battery Y1 | | | | | | | | |
| Comparative | 85/15 | 50 | 50 | — | N.G. | N.G. | O.K. | 83% |
| battery X2 | | | | | | | | |
| Inventive | 80/20 | 50 | 50 | — | O.K. | O.K. | O.K. | 84% |
| battery B7 | | | | | | | | |
| Inventive | 50/50 | 50 | 50 | — | O.K. | O.K. | O.K. | 81% |
| battery A7 | | | | | | | | |
| Comparative | 45/55 | 50 | 50 | — | O.K. | O.K. | O.K. | 64% |
| battery Y2 | | | | | | | | |

Each of the comparative batteries X1, X2, Y1 and Y2 used an organic solvent having an organic solvent content ratio within the scope of the invention. In each of the comparative batteries X1 and X2 in which the mass ratio of positive electrode active materials, that is, the mass ratio of lithium cobalt oxide (LiCoO₂) to lithium manganese oxide (LiMn₂O₄) was 85/15, it was however found from the results of Table 1 that both 2It-overcharge test and 150° C. thermal test were N.G. In each of the comparative batteries Y1 and Y2 in which the mass ratio was 45/55, it was further found from the results of Table 1 that 60° C. cycle characteristic became lower than that of each of the batteries according to the invention.

It is obvious from these results that a good 2It-overcharge test result, a good 150° C. thermal test result and a good 60° C. cycle characteristic result can be obtained when the mass ratio of active materials, that is, the mass ratio of lithium cobalt oxide (LiCoO₂) to lithium manganese oxide (LiMn₂O₄) is in a range of from 50/50 to 80/20.

7. Examination of Amounts of Ethylene Carbonate Additive and Propylene Carbonate Additive

Next, the batteries A1, A2, A4 to A7, B1, B2 and B4 to B7 according to the invention and the comparative batteries W2 to W6 and Z2 to Z6 were used. In the condition that the PC content was changed, results of the tests were shown in Table 2.

TABLE 2
Influence of PC Content on Characteristic

| | Active | | | | | | | |
|---|---|---|---|---|---|---|---|---|
| | material | | | | 2It | | 80° C. 4-day | 60° C. |
| | mass ratio | | | | over- | 150° C. | preservation | cycle |
| | LiCoO₂/ | EC | PC | DEC | charge | thermal | after | characteristic |
| | LiMn₂O₄ | (vol %) | (vol %) | (vol %) | test | test | charge | (%) |
| Comparative | 80/20 | 25 | 0 | 75 | O.K. | N.G. | N.G. | 82% |
| battery W2 | | | | | | | | |
| Inventive | 80/20 | 25 | 5 | 70 | O.K. | O.K. | O.K. | 86% |
| battery B1 | | | | | | | | |
| Inventive | 80/20 | 25 | 25 | 50 | O.K. | O.K. | O.K. | 86% |
| battery B2 | | | | | | | | |
| Comparative | 80/20 | 25 | 30 | 45 | O.K. | O.K. | O.K. | 71% |
| battery W3 | | | | | | | | |
| Comparative | 80/20 | 40 | 0 | 60 | O.K. | N.G. | N.G. | 84% |
| battery W4 | | | | | | | | |
| Inventive | 80/20 | 40 | 5 | 55 | O.K. | O.K.. | O.K. | 84% |
| battery B4 | | | | | | | | |
| Inventive | 80/20 | 40 | 40 | 20 | O.K. | O.K. | O.K. | 83% |
| battery B5 | | | | | | | | |
| Comparative | 80/20 | 40 | 45 | 15 | O.K. | O.K. | O.K. | 72% |
| battery W5 | | | | | | | | |
| Comparative | 80/20 | 50 | 0 | 50 | O.K. | N.G. | N.G. | 82% |
| battery W6 | | | | | | | | |
| Inventive | 80/20 | 50 | 5 | 45 | O.K. | O.K. | O.K. | 84% |
| battery B6 | | | | | | | | |
| Inventive | 80/20 | 50 | 50 | — | O.K. | O.K. | O.K. | 84% |
| battery B7 | | | | | | | | |
| Comparative | 50/50 | 25 | 0 | 75 | O.K. | O.K. | N.G. | 83% |
| battery Z2 | | | | | | | | |
| Inventive | 50/50 | 25 | 5 | 70 | O.K. | O.K. | O.K. | 84% |
| battery A1 | | | | | | | | |
| Inventive | 50/50 | 25 | 25 | 50 | O.K. | O.K. | O.K. | 82% |
| battery A2 | | | | | | | | |
| Comparative | 50/50 | 25 | 30 | 45 | O.K. | O.K. | O.K. | 68% |
| battery Z3 | | | | | | | | |
| Comparative | 50/50 | 40 | 10 | 60 | O.K. | O.K. | N.G. | 81% |
| battery Z4 | | | | | | | | |
| Inventive | 50/50 | 40 | 5 | 55 | O.K. | O.K. | O.K. | 82% |
| battery A4 | | | | | | | | |
| Inventive | 50/50 | 40 | 40 | 20 | O.K. | O.K. | O.K. | 82% |
| battery A5 | | | | | | | | |
| Comparative | 50/50 | 40 | 45 | 15 | O.K. | O.K. | O.K. | 67% |
| battery Z5 | | | | | | | | |
| Comparative | 50/50 | 50 | 0 | 50 | O.K. | O.K. | N.G. | 84% |
| battery Z6 | | | | | | | | |
| Inventive | 50/50 | 50 | 5 | 45 | O.K. | O.K. | O.K. | 84% |
| battery A6 | | | | | | | | |
| Inventive | 50/50 | 50 | 50 | — | O.K. | O.K. | O.K. | 81% |
| battery A7 | | | | | | | | |

It was obvious from Table 2 that there was no swelling in the 80° C. 4-day preservation after charge and a good 150° C. thermal test result and a good 60° C. cycle characteristic were obtained when the PC content was not smaller than 5% by volume but not larger than the EC content. On the contrary, when the PC content was smaller than 5% by volume, swelling occurred in the 80° C. 4-day preservation after charge and a poor 150° C. thermal test result was obtained.

It was further found that 60° C. cycle characteristic was lowered when the PC content was larger than the EC content.

Next, the batteries A1, A4, A6, B1, B4 and B6 according to the invention and the comparative batteries W1, W7, Z1 and Z7 were used. In the condition that the EC content was changed, results of the tests were shown in Table 3.

TABLE 3
Influence of EC Content on Characteristic

| | Active | | | | | | | |
|---|---|---|---|---|---|---|---|---|
| | material | | | | 2It | | 80° C. 4-day | 60° C. |
| | mass ratio | | | | over- | 150° C. | preservation | cycle |
| | LiCoO₂/ | EC | PC | DEC | charge | thermal | after | characteristic |
| | LiMn₂O₄ | (vol %) | (vol %) | (vol %) | test | test | charge | (%) |
| Comparative | 80/20 | 20 | 5 | 75 | N.G. | O.K. | O.K. | 85% |
| battery W1 | | | | | | | | |
| Inventive | 80/20 | 25 | 5 | 70 | O.K. | O.K. | O.K. | 86% |
| battery B1 | | | | | | | | |
| Inventive | 80/20 | 40 | 5 | 55 | O.K. | O.K. | O.K. | 84% |
| battery B4 | | | | | | | | |
| Inventive | 80/20 | 50 | 5 | 4.5 | O.K. | O.K. | O.K. | 84% |
| battery B6 | | | | | | | | |
| Comparative | 80/20 | 55 | 5 | 40 | O.K. | N.G. | N.G. | 83% |
| battery W7 | | | | | | | | |
| Comparative | 50/50 | 20 | 5 | 75 | N.G. | O.K. | O.K. | 83% |
| battery Z1 | | | | | | | | |
| Inventive | 50/50 | 25 | 5 | 70 | O.K. | O.K. | O.K. | 84% |
| battery A1 | | | | | | | | |
| Inventive | 50/50 | 40 | 5 | 55 | O.K. | O.K. | O.K. | 82% |
| battery A4 | | | | | | | | |
| Inventive | 50/50 | 50 | 5 | 45 | O.K. | O.K. | O.K. | 84% |
| battery A6 | | | | | | | | |
| Comparative | 50/50 | 55 | 5 | 40 | O.K. | O.K. | N.G. | 82% |
| battery Z7 | | | | | | | | |

It was obvious from Table 3 that 2It-overcharge test results were poor when the EC content was 20% by volume. When the EC content was larger than 55% by volume, 2It-overcharge test results were good but swelling occurred in the 80° C. 4-day preservation after charge. It is found from these results that there is no swelling in the 80° C. 4-day preservation after charge and a good 150° C. thermal test result is obtained when the EC content is not smaller than 25% by volume but not larger than 50% by volume.

Finally, the batteries A1, A3, A4, A6, B1, B3, B4 and B6 according to the invention and the comparative batteries W1, W7, Z1 and Z7 were used. In the condition that only the EC content was changed while the PC content was kept constant, results of the tests were shown in Table 4.

Incidentally, results of a 3It-overcharge test and a 5It-overcharge test as other overcharge tests than the 2It-overchage test in the tests were further shown in Table 4. In the 3It-overcharge test, each battery was charged at a charging current of 1800 mA (3It). In the 5It-overcharge test, each battery was charged at a charging current of 3000 mA (5It).

TABLE 4
More Preferable EC Content → 30 vol % or higher

| | Active | | | | | | | | | |
|---|---|---|---|---|---|---|---|---|---|---|
| | material | | | | | | | | 80° C. 4-day | 60° C. |
| | mass ratio | | | | | | | 150° C. | preservation | cycle |
| | LiCoO₂/ | EC | PC | DEC | Overcharge test | | | thermal | after | characteristic |
| | LiMn₂O₄ | (vol %) | (vol %) | (vol %) | 2It | 3It | 5It | test | charge | (%) |
| Comparative | 80/20 | 20 | 5 | 75 | N.G. | N.G. | N.G. | O.K. | O.K. | 85% |
| battery W1 | | | | | | | | | | |
| Inventive | 80/20 | 25 | 5 | 70 | O.K. | N.G. | N.G. | O.K. | O.K. | 86% |
| battery B1 | | | | | | | | | | |
| Inventive | 80/20 | 30 | 5 | 65 | O.K. | O.K. | N.G. | O.K. | O.K. | 85% |
| battery B3 | | | | | | | | | | |
| Inventive | 80/20 | 40 | 5 | 55 | O.K. | O.K. | N.G. | O.K. | O.K. | 84% |
| battery B4 | | | | | | | | | | |
| Inventive | 80/20 | 50 | 5 | 45 | O.K. | O.K. | N.G. | O.K. | O.K. | 84% |
| battery B6 | | | | | | | | | | |
| Comparative | 80/20 | 55 | 5 | 40 | O.K. | O.K. | N.G. | N.G. | N.G. | 83% |
| battery W7 | | | | | | | | | | |
| Comparative | 50/50 | 20 | 5 | 75 | N.G. | N.G. | N.G. | O.K. | O.K. | 83% |
| battery Z1 | | | | | | | | | | |
| Inventive | 50/50 | 25 | 70 | O.K. | O.K. | N.G. | O.K. | O.K. | 84% | |
| battery A1 | | | | | | | | | | |
| Inventive | 50/50 | 30 | 5 | 65 | O.K. | O.K. | O.K. | O.K. | O.K. | 85% |
| battery A3 | | | | | | | | | | |
| Inventive | 50/50 | 40 | 5 | 55 | O.K. | O.K. | O.K. | O.K. | O.K. | 82% |
| battery A4 | | | | | | | | | | |
| Inventive | 50/50 | 50 | 5 | 45 | O.K. | O.K. | O.K. | O.K. | O.K. | 84% |
| battery A6 | | | | | | | | | | |
| Comparative | 50/50 | 55 | 5 | 40 | O.K. | O.K. | O.K. | O.K. | N.G. | 82% |
| battery Z7 | | | | | | | | | | |

It was obvious from Table 4 that 3It-overcharge test results were good when the EC content was not smaller than 30% by volume.

Accordingly, more preferably, the EC content is selected to be not smaller than 30% by volume.

Although the embodiment has been described on the case where the invention is applied to a polymer battery (polymer electrolyte battery), the invention may be also applied to a lithium ion battery.

Incidentally, the concept “polymer” herein used means a gelated polymer electrolyte constituted by a combination of lithium salt, an organic solvent and a high-molecular compound selected from the group consisting of a polyether-based solid high-molecular compound, a polycarbonate-based solid high-molecular compound, a polyacrylonitrile-based high-molecular compound, a copolymer or crosslinked high-molecular compound made of two or more kinds of these high-molecular compounds, and a fluorine-based solid high-molecular compound such as polyvinylidene fluoride (PVdF).

Although the embodiment has been described on the case where the MECHANO FUSION system is used for generating compression, impact and shear action to mix lithium manganese oxide and lithium cobalt oxide with each other to bring lithium cobalt oxide into electrical contact with lithium manganese oxide, the invention may be also applied to the case where these materials are mixed with each other in a slurry state without use of the MECHANO FUSION system.

In addition, the same effect as described above can be also obtained in the case where different kinds of elements are added to lithium manganese oxide and lithium cobalt oxide as positive electrode active materials.

As described above, in accordance with the invention, the mass ratio of positive electrode active materials, that is, the mass ratio of lithium cobalt oxide to lithium manganese oxide is in a range of from 50/50 to 80/20. Lithium salt dissolved in an organic solvent is used as the electrolyte. The organic solvent contains ethylene carbonate (EC), and propylene carbonate (PC). The EC content is not smaller than 25% by volume but not larger than 50% by volume with respect to the total amount of the organic solvent. The PC content is not smaller than 5% by volume but not larger than the EC content with respect to the total amount of the organic solvent. Hence, by use of the organic solvent, there can be provided a non-aqueous electrolyte battery which has safety kept high and which is small in swelling at the time of high-temperature preservation and excellent in high-temperature cycle characteristic.

What is claimed is:

1. A non-aqueous electrolyte battery comprising:
an outer container;
a positive electrode and a negative electrode disposed in said outer container; and
an electrolyte disposed between said positive and negative electrodes; wherein:
said positive electrode contains lithium cobalt oxide and lithium manganese oxide as active materials;
a mass ratio of lithium cobalt oxide to lithium manganese oxide is in a range of from 50/50 to 80/20;
said electrolyte includes lithium salt dissolved in an mixture solvent which contains ethylene carbonate (EC) and propylene carbonate (PC);
the EC content is not smaller than 25% by volume but not larger than 50% by volume with respect to the total amount of the mixture solvent; and
the PC content is not smaller than 5% by volume but not larger than the EC content with respect to the total amount of the mixture solvent.

2. A non-aqueous electrolyte battery according to claim 1, wherein said electrolyte is thermally polymerized to be gelated by adding a polymerizable compound containing a compound having either acryloyl group (CH₂═CHCO—O—) or methacryloyl group (CH₂═C(CH₃)CO—O—).
